(19) United States
(12) Patent Application Publication
(10) Pub. No.: US 2005/0019480 A1
(43) Pub. Date: Jan. 27, 2005

(54) Alkaline health food and method for production thereof

(76) Inventors: Hideo Ueda, Tokyo (JP); Jongap Kim, NonSan City (KR); J.W. Jo, Mokpo City (KR)

Correspondence Address: Kanesaka & Takeuchi, Suite 2, 1423 Powhatan Street, Alexandria, VA, 22314, US

(21) Appl. No.: 10/489,218

(22) PCT Filed: Sep. 14, 2001
(86) PCT No.: PCT/JP01/08016

(51) Int. Cl. A23L 1/30

(52) U.S. Cl. 426/648

(57) ABSTRACT

The present invention relates to an alkaline health food useful for maintaining health of the body and to a method for production thereof. The present invention provides an alkaline health food having a high reduction capacity and containing a large quantity of mineral components. Seawater is introduced into a salt field provided with a difference of altitude. Seawater is gradually guided from zones with a high altitude to zones with a low altitude, producing salty water with a high salt concentration. Crystals of the salty water are precipitated to form coarse salt which is fired at a temperature of 700-1600 ° C. In the aqueous solution of the health food in accordance with the present invention, which is obtained in the above-described manner, the redox potential is from −10 mV to −620 mV and the mineral content is 4 to 10 wt. %.

### TECHNICAL FIELD

This invention relates to an alkaline health food with a powerful reductive action and a high mineral content, and to a method for producing the same.

### BACKGROUND ART

Reductive water has been recognized by many people as having a beneficial effect on the body. Cathode water and anode water are obtained when tap water is filtered to remove impurities and then electrolyzed in an electrolytic tank, and the resulting cathode water exhibits a negative value for redox potential. Because it has a negative redox potential and has reducing power, cathode water is therefore called reductive water.

Reductive water has the action of eliminating active oxygen in the body. Active oxygen can oxidize biological molecules, and this damages genes and cells, creating factors that can lead to various kinds of disease. Reductive water imparts electrons to active oxygen and thereby inhibits the oxidation of biological molecules by active oxygen, and thus serves to suppress the occurrence of disease.

However, reductive water made with an electrolyzer does not exhibit enough potential on the reduction side to achieve a satisfactory redox potential, and therefore cannot be considered to have adequate reducing power. Another drawback is that the redox potential varies over time, making a transition from the negative to the positive side, which means that reducing power is lost as time passes. Furthermore, the mineral content of such reductive water is low, making it lacking in quality for a health beverage.

The applicant has already proposed the invention of an alkaline health food produced by baking natural salt at 500 to 2000° C., and have also proposed a method for producing an alkaline health food wherein natural salt is packed into a container, the lid of the container is closed, and the salt is baked at 500 to 2000° C. and then cooled and pulverized (Japanese Patent No. 2,092,094). With the invention in this Patent No. 2,092,094, a redox potential is obtained with a large negative value (a negative numerical value indicates reductivity); for example, this invention discloses redox potentials of −303 mV (Example 1), −204 mV (Example 3), and −163 mV (Example 4).

Today, however, there is a need for the development of an alkaline health food that has greater reducing power and has a high mineral content.

The present invention is an improvement to Patent No. 2,092,094, and it is an object thereof to provide an alkaline health food with greater reducing power.

Moreover, it is an object of the present invention to provide an alkaline health food that has a high mineral content and is beneficial in terms of keeping the body functions.

It is a further object of the present invention to provide a method for producing an alkaline health food with which the producing process is simpler than that in Patent No. 2,092,094 and the production efficiency is increased.

### DISCLOSURE OF THE INVENTION

The present invention is an alkaline health food, produced by baking natural salt at 700 to 1600° C., wherein the redox potential in an aqueous solution is from −10 mV to −620 mV. The alkaline health food of the present invention is rich in minerals, having a mineral content of 4 to 10 wt %. The raw material of the health food of the present invention is natural salt, but it is preferable to use sun-dried salt as this natural salt. The natural salt is baked at 700 to 1600° C. and then cooled to obtain a block of salt, and this block is then pulverized into a powder or granules.

The coarse salt that serves as the producing raw material of the health food of the present invention is made by a salt-field salt production method. The salt field is preferably terraced, and seawater flows successively down from higher levels to lower levels. Some of the water in the seawater is evaporated by solar heat to produce salt water (kansui) with a higher salt concentration than the seawater. More of the water in this salt water (kansui) is then evaporated to raise the salt concentration further and precipitate crystals of salt water (kansui), grow said crystals, and produce coarse salt.

The coarse salt thus obtained is baked at 700 to 1600° C. In this case, the baking is preferably divided up into three stages, with the first stage baking performed at 700 to 1000° C., the second stage baking at 1000 to 1400° C., and the third stage baking at 1400 to 1600° C.

In order to increase the reducing power of the health food of the present invention, it is preferable to mix the extract of a plant having reducing power into the baked salt during the baking.

Because its redox potential in an aqueous solution is from −10 to −620 mV, the alkaline health food of the present invention has strong reducing power, and as a result, when the health food of the present invention is ingested, it serves to maintain good health and prevent disease. Specifically, a food with a high reducing power works to impart electrons to active oxygen in the body, the result of which is that it suppresses the action of active oxygen (oxidizing biological molecules and damaging genes or cells) and thereby prevents the occurrence of disease.

Also, the alkaline health food of the present invention contains a large amount of minerals, and can be dissolved in water and used as alkaline ion water, which is beneficial in terms of keeping the body healthy when made into a beverage or a health drink.

With the present invention, in the production of the coarse salt, seawater is introduced into a salt field provided with a difference of altitude, and the seawater is successively guided from zones of higher altitude to zones of lower altitude, so large quantities of the natural mineral components contained in the salt field are dissolved into the seawater, and the coarse salt thus obtained contains large quantities of mineral components. Thus, since coarse salt with a high mineral content is used in the present invention, even if the number of bakings is reduced in the baking of the coarse salt, it is still possible to production a health food with a high reducing power (a redox potential of −10 to −620 mV in an aqueous solution), and therefore the producing process is simplified and production efficiency is enhanced.

### BRIEF DESCRIPTION OF THE DRAWINGS

FIG. 1 is a vertical cross section of the main components of the terraced salt field provided with a difference of altitude that is used in the producing method of the present invention.

### BEST MODE FOR CARRYING OUT THE INVENTION

The alkaline health food of the present invention is produced by baking natural salt at 700 to 1600° C. Below 700° C., it will be difficult to obtain a redox potential that affords good reducing power, and the mineral content will also be inadequate. It is also undesirable to exceed 1600° C., though, because some of the minerals will decompose. The preferred baking temperature range is from 900 to 1400° C.

Sun-dried salt is preferable as the natural salt, and sun-dried salt produced using a terraced salt field as discussed below is particularly favorable.

A property of the health food of the present invention is that it has a redox potential of −10 to −620 mV when dissolved in water to produce an aqueous solution. This redox potential value of from −10 to −620 mV means that the product has good reducing power. Specifically, when the numerical value indicating the redox potential is negative, it indicates that the product is reductive, and the greater is the absolute value thereof, the better is the reducing power. Conversely, a positive numerical value for potential means that the product is oxidative. In the present invention, the preferred redox potential is from −150 to −620 mV.

The health food of the present invention is rich in minerals, having a mineral content of 4 to 10 wt %. Examples of the main mineral components contained include potassium, magnesium, calcium, iron, and manganese.

When the natural salt is baked at 700 to 1600° C. and then cooled, a block of salt is obtained, and this block is pulverized into a powder or granules.

In the production of the health food of the present invention, it is preferable to use sun-dried salt made in a salt field as the raw material salt. Sun-dried salt is produced in a salt field, and in the present invention a salt field provided with a difference in altitude is used, and seawater is moved from the higher levels to the lower levels. It is preferable for this salt field provided with a difference in altitude to be a terraced salt field provided with different levels. In addition to the terraced type mentioned above, the salt field provided with a difference in altitude in the present invention can also be a salt field that slopes continuously and linearly. In any case, the overall angle of slope must be gentle enough that the seawater does not move too fast.

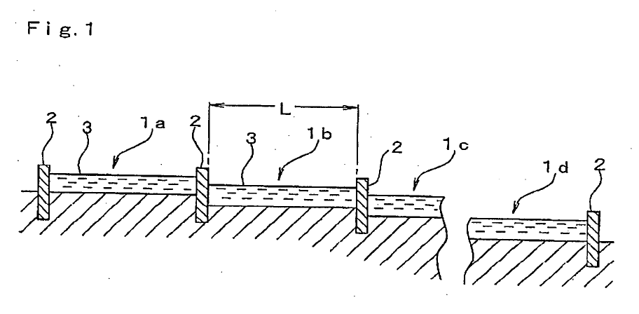

FIG. 1 illustrates a terraced salt field provided with a difference in altitude. This terraced salt field comprises a plurality of salt field sections 1a, 1b, 1c, and id corresponding to the number of levels. The levels may be continuous in only one direction, or may be continuous both vertically and horizontally. If the levels are continuous in only one direction, then this terraced salt field is provided as numerous parallel rows.

The bottoms of the sections 1a, 1b, 1c, and 1d may be horizontal or somewhat sloped. Each of the salt field sections 1a, 1b, 1c, and 1d is surrounded by a border 2, and this border 2 serves as a partition demarcating the salt field sections 1a, 1b, 1c, and 1d from one another. The salt field sections are demarcated as square salt fields by the borders 2.

The distance L between the various salt field sections 1a, 1b, 1c, and 1d (that is, the distance of the floor in a single salt field section) is preferably 25 to 35 meters. If the distance L between levels is too short, the seawater residence time in each salt field section will be too short and not enough water will be evaporated, and furthermore the mineral components contained in the soil of the salt field will not be sufficiently dissolved into the seawater.

Just as with a farming field, the soil in the salt field is plowed deeply under once a year, and is allowed to rest about six months until microbes proliferate. Once this cultivation period has elapsed, seawater is drawn into the salt field. First, the seawater 3 is introduced into salt field section 1a, and then after remaining in this salt field section 1a for a specific length of time, it flows into the next lower salt field section 1b. Although not especially depicted in the drawing, communicating passages are provided between one salt field section and the salt field section located at the next lower level, and the seawater flows from the upper salt field section to the lower salt field section through these communicating passages. In one salt field section, the communicating passages are closed off when seawater is to be retained for a specific period, and the communicating passages are opened up after this specific period has elapsed and the seawater is to be allowed out.

The means for opening and closing these communicating passages can be as follows, for example. Blockers that block off the communicating passages are removably attached to the communicating passages, and the communicating passages are blocked off by inserting these blockers into the communicating passages, or the blockers are taken out of the communicating passages to open up the passages.

While the seawater 3 is held within the salt field section 1a, water is gradually evaporated by solar heat and wind, which raises the salt concentration. Also, any mineral components contained in the soil of the salt field are dissolved into the seawater 3, which raises the mineral concentration in the seawater 3 as well. The seawater 3 whose salt and mineral concentrations have thus been raised within the salt field section 1a is then allowed to flow into the salt field section 1b at the next lower level, whereupon water is similarly evaporated by solar heat and wind, which further raises the salt concentration, and any mineral components contained in the soil of the salt field are also dissolved in the seawater 3, which further raises the mineral concentration in the seawater 3. In this manner, the seawater 3 successively flows to the lower salt field sections, and the salt and mineral concentrations in the seawater steadily rise as the water moves downward in this fashion. Since a terraced salt field is used in the present invention, any harmful substances contained in the seawater are decomposed and rendered nontoxic by the solar heat.

While the seawater is slowly moving through the salt field, any pollutants in the seawater gradually rise to the surface of the water and are removed. Some kinds of pollutants may be absorbed into the soil of the salt field. The seawater is then guided from a salt field section to a cooling pond, where it remains and is cooled for about a week so that any other harmful substances will precipitate out. Once these harmful substances have been removed, the seawater is guided back to the salt field section, and the above process of allowing the water to stand in each salt field section and flow down to the next salt field section is continued. The salt water (kansui) obtained by this process can be adjusted to a high quality.

The salt field is preferably one whose soil is rich in germanium. Germanium has the property of absorbing pollutants and harmful substances in seawater, and turns black when these substances have been absorbed and oxidized. This black coloring makes the absorption of solar heat more efficient, raises the seawater temperature, and as a result promotes the dissolution of the mineral components in the soil into the seawater, allowing a larger amount of minerals to be dissolved in the seawater.

Salt water (kansui) with an extremely high salt concentration is produced at the final level of the salt field sections. This salt water (kansui) is stored just as it is in the salt field section, where more water is evaporated to precipitate salt crystals in the salt water (kansui). For these crystals of salt to be precipitated, it is important for the solar heat to be absorbed efficiently. Accordingly, it is preferable to line of the bottom of the final salt field section with a sheet of heat-resistant black rubber felt.

With time, the crystals of salt grow larger, producing coarse salt. This coarse salt is collected and baked. The baking is performed between 700 and 1600° C., and baking in three separate stages is preferred. In the case of three-stage baking, the first stage baking is performed at 700 to 1000° C., the second stage baking at 1000 to 1400° C., and the third stage baking at 1400 to 1600° C.

In performing the baking, it is preferable to mix the extract of a plant having reducing power into the coarse salt. Mixing such a plant extract into the coarse salt allows the redox potential of the health food that is produced to be raised to a higher numerical value for reducing power. Garlic, onion, pine needle, kelp, sesame, licorice, and Magnolia bark, either singly or as a mixture of two or more types, are favorable as the plant having reducing power, but the present invention is not limited to these. These plants are boiled in water, after which the product is filtered and the supernatant is used as a plant extract.

For example, in the case of licorice and Magnolia bark, 200 g of each is added to 10 liters of water and heated for several hours, boiling down the solution until its volume is about 8.5 liters. This product is then filtered and the supernatant is used as an extract of licorice and Magnolia bark. The redox potential of an extract of licorice and Magnolia bark is approximately −60 mV.

The amount of the above-mentioned plant extract mixed into the coarse salt is preferably 1 to 5 wt % with respect to the coarse salt. The extract of a plant having reducing power may be admixed at any stage of the process, but mixing into the baked salt during the second baking and the third baking is preferred.

When the baking is carried out in three stages as above, the coarse salt is placed in a furnace and first subjected to the first stage baking. The preferable temperature of the first stage baking is 800 to 900° C., and the baking time is 4 to 6 hours. After baking, the salt is allowed to cool naturally.

The baked salt obtained from the first stage baking is in the form of a block, so this block is pulverized into a powder, an extract of a plant having reducing power is mixed into this powder, and the mixture is packed into a bamboo tube and subjected to the second stage baking. The preferable temperature of the second stage baking is 1000 to 1200° C., and the baking time is 5 to 10 hours. In this baking, preferably the bamboo tube packed with the baked salt and extract mixture is placed in a ceramic furnace and baked. Hydrogen gas, Japanese red pine firewood, pine sap, or the like can be used as fuel. The bamboo tube is incinerated during this baking.

After baking, the salt is allowed to cool naturally. The cooling time will be from 75 to 85 hours. This second stage baking is preferably performed twice. If performed twice, the block of baked salt obtained from the first baking is pulverized into a powder, and then just as in the first baking, an extract of a plant having reducing power is mixed in, this baked salt and extract mixture is packed into a bamboo tube, and baking is performed under the same conditions as the first time. Repeating the baking in this manner makes it possible to production a salt having higher reducing power.

After the second stage baking, the salt is allowed to cool naturally, the resulting block of baked salt is pulverized into a powder, and just as above, an extract of a plant having reducing power is mixed in and the third stage baking is performed. The preferable temperature of the third stage baking is 1400 to 1500° C., and the baking time is from 5 to 10 hours. Since the baking temperature at this stage is quite high, it is preferable to perform the baking with the baked salt in a ceramic crucible. This high-temperature baking decomposes and removes any pollutants and harmful substances.

The result of baking at 1400 to 1500° C. is that the salt is in the form of a thick melt. After baking, the salt is allowed to cool naturally. The cooling time will be from 75 to 85 hours. After cooling, the block of baked salt thus obtained is taken out of the crucible, and the block is pulverized to obtain a powdered finished product.

The form of the alkaline health food of the present invention is not limited to that of a powder, and can also be that of large or small granules. The health food of the present invention can be eaten just as it is, or it can be dissolved in water and drunk as alkaline ion water. It can also be used as a seasoning just like regular salt. The health food of the present invention does taste like table salt, but is not that salty.

The present invention can also be made into a finished product by admixing inorganic salts, cinnamon, dry ginger, or other such additives as needed to the powdered baked salt obtained from the baking steps discussed above.

Examples of the present invention will now be given.

### EXAMPLES

Coarse salt was produced using a terraced salt field, and this coarse salt was collected, put into a ceramic furnace, and baked for 5 hours at 900° C. (first stage baking). Upon completion of the first stage baking, the salt was allowed to stand and cool, the block of baked salt thus obtained was pulverized into a powder, and to this was added an extract of licorice and Magnolia bark in an amount of 2 wt % with respect to the baked salt. The baked salt and extract mixture was packed into a bamboo tube, which was then placed in the above-mentioned ceramic furnace and baked for 10 hours at 1200° C. (second stage baking). The bamboo tube was completely burned away during this baking. Upon completion of the second stage baking, the salt was allowed to stand and cool for 80 hours. This baking step was performed twice.

Specifically, the block of baked salt obtained in the first baking of the second stage baking was pulverized into a powder, and then just as the first time, an extract of licorice and Magnolia bark was added to this in an amount of 2 wt % with respect to the baked salt, and this baked salt and extract mixture was packed into a bamboo tube and baked for 10 hours at 1200° C.

Upon completion of the second stage baking, the salt was allowed to stand and cool, the block of baked salt thus obtained was pulverized into a powder, and to this was added an extract of licorice and Magnolia bark in an amount of 2 wt % with respect to the baked salt. The baked salt and extract mixture was packed into a ceramic crucible, which was then placed in the above-mentioned ceramic furnace and baked for 10 hours at 1400° C. (third stage baking). The baked salt was in the form of a thick melt that was bright red in color, and it was confirmed that the salt was completely molten.

Upon completion of the baking, the salt was allowed to stand and cool for 80 hours. After cooling, the block of baked salt was taken out of the crucible and pulverized to obtain a powdered finished product. Hydrogen gas, Japanese red pine firewood, and pine sap were used as fuel in the various baking steps.

The components of the baked salt (health food of the present invention) thus obtained were analyzed, the results of which are given in Table 1.

TABLE 1

| Component | Composition | | Analysis method |
|---|---|---|---|
| Chlorine | 56.6% | | Mohr's method |
| Sodium | 37.3% | | atomic absorption |
| | | | spectrophotometry |
| Gallium | 7650 | ppm | atomic absorption |
| | | | spectrophotometry |
| Magnesium | 6730 | ppm | atomic absorption |
| | | | spectrophotometry |
| Silicon | 5710 | ppm | molybdenum blue |
| | | | spectrophotometry |
| Sulfur | 4000 | ppm | barium sulfate weight |
| | | | method |
| Potassium | 3280 | ppm | permanganic acid |
| | | | volume method |
| Calcium | 1800 | ppm | atomic absorption |
| | | | spectrophotometry |
| Iron | 1100 | ppm | o-phenanthroline |
| | | | spectrophotometry |
| Phosphorus | 831 | ppm | vanadomolybdic |
| | | | acid spectrophotometry |
| Bromine | 232 | ppm | iodine titration |
| Strontium | 84 | ppm | atomic absorption |
| | | | spectrophotometry |
| Zinc | 57.10 | ppm | atomic absorption |
| | | | spectrophotometry |
| Boron | 14.00 | ppm | curcumin |
| | | | spectrophotometry |
| Barium | 12.00 | ppm | ICP emission |
| | | | analysis |
| Molybdenum | 9.00 | ppm | ICP emission |
| | | | analysis |
| Copper | 5.70 | ppm | atomic absorption |
| | | | spectrophotometry |
| Lithium | 1.00 | ppm | atomic absorption |
| | | | spectrophotometry |
| Lead | 0.65 | ppm | atomic absorption |
| | | | spectrophotometry |
| arsenic | 0.30 | ppm | DDTC-Ag |
| | | | spectrophotometry |

Next, 6 g of the baked salt (health food) of the present invention was dissolved in 100 cc of tap water to prepare an aqueous solution, and the redox potential of this aqueous solution was measured. For the sake of comparison, salt aqueous solutions of the same concentration were also prepared for natural salt, natural baked salt, refined salt (chemical salt), and refined baked salt, and the redox potentials were measured. The same measurement was also performed for alkaline ion water made with a household apparatus for making alkaline ion water. Further, the same measurement was also performed for the above-mentioned salt aqueous solutions.

The redox potential was measured using a redox potential measurement device made by Toa Denpa Kogyo Corporation. These results are given in Table 2.

TABLE 2

| | Redox potential |
|---|---|
| | (mV) |
| Baked salt of present invention (upon | −158 |
| completion of first stage baking) | |
| Baked salt of present invention (upon | −575 |
| completion of third stage baking) | |
| Natural salt | +263 |
| Natural baked salt | +121 |
| Refined salt (chemical salt) | +282 |
| Refined baked salt | +136 |
| Alkaline ion water | −112 |
| Tap water (from Shibuya Ward in Tokyo) | +610 |

It can be seen from Table 2 that the redox potential of the baked salt of the present invention has a large negative value, which means that it has good reducing power.

### Industrial Applicability

The health food of the present invention can be eaten just as it is, or it can be dissolved in water and drunk as alkaline ion water, and is beneficial at keeping the body healthy when made into a reductive health food.

1. An alkaline health food, produced by baking natural salt at 700 to 1600° C., wherein the redox potential in an aqueous solution is from −10 mV to −620 mV.

2. The alkaline health food according to claim 1, wherein the mineral content is 4 to 10 wt %.

3. An alkaline health food, produced by baking natural salt at 700 to 1600° C., wherein the mineral content is 4 to 10 wt %.

4. An alkaline health food, wherein the redox potential in an aqueous solution is from −10 mV to −620 mV, and the mineral content is 4 to 10 wt %.

5. A method for producing an alkaline health food, comprising the steps of:
introducing seawater into a salt field provided with a difference of altitude;
successively guiding the seawater from zones of higher altitude to zones of lower altitude;
evaporating water from the seawater with solar heat to produce salt water (kansui) with a salt content higher than that of the seawater;
evaporating water from this salt water (kansui) to precipitate crystals of salt water (kansui) and produce coarse salt; and
baking said coarse salt at 700 to 1600° C.

6. The method for producing an alkaline health food according to claim 5, wherein the salt field provided with a difference of altitude is a terraced salt field.

7. The method for producing an alkaline health food according to claim 5, wherein an extract of a plant having reducing power is mixed into the coarse salt before the baking is performed.

8. The method for producing an alkaline health food according to claim 7, wherein the plant having reducing power is one type or a mixture of at least two types of plants selected from among garlic, onion, pine needle, kelp, sesame, licorice, and Magnolia bark.

9. The method for producing an alkaline health food according to claim 5, wherein the baking is performed in three separate stages, with the first stage baking performed at 700 to 1000° C., the second stage baking at 1000 to 1400° C., and the third stage baking at 1400 to 1600° C.

10. The method for producing an alkaline health food according to claim 9, wherein the extract of a plant having reducing power is mixed into the baked salt during the second stag baking and third stage baking.

11. The method for producing an alkaline health food according to claim 9, wherein the second stage baking is repeated twice.
